(19) United States
(12) Patent Application Publication
(10) Pub. No.: US 2012/0154291 A1
(43) Pub. Date: Jun. 21, 2012

(54) KEY INPUT DEVICE

(76) Inventor: Kiyoshi ABE, Kanagawa (JP)

(21) Appl. No.: 13/324,256

(22) Filed: Dec. 13, 2011

(30) Foreign Application Priority Data
Dec. 20, 2010 (JP) P2010-282893

(51) Int. Cl. G06F 3/02

(52) U.S. Cl. 345/170

(57) ABSTRACT

The present disclosure provides a key input device including plural keycaps used to manipulate key switches, respectively, a backlight radiating a light from a back to the keycap, and a board on which a signal line pattern forming a contact point adapted to be opened or closed in accordance with an up-and-down motion of corresponding one of the plural keycaps, and an electric power line pattern through which an electric power is supplied to the backlight are printed.

### BACKGROUND

The present disclosure relates to a key input device used for an input operation in an information processor, and more particularly to a key input device in which a keycap transmits a light radiated from a backlight.

In order to assist a manipulation for an information processor in a dark environment, in recent years, an information processor having a lighted (i.e., translucent) manipulation portion has been developed. For example, Japanese Patent Laid-Open No. 2010-118311 discloses a keyboard including keycaps, a gear link portion, a housing portion, a rubber actuator, a membrane sheet, a support panel, a light guide plate, and a light emitting diode. In this case, the gear link portion causes the keycap to make an up-and-down motion. The housing portion holds the gear link portion. The support panel fixes the gear link portion by using the housing portion. The light emitting diode causes a light to be made incident to the light guide plate. Also, any of keys transmits a light.

### SUMMARY

In the keyboard described above, however, the number of constituent parts or components is large. For this reason, there is caused a problem that assembly man-hours become large, and thus a material cost becomes high.

The present disclosure has been made in order to solve the problems described above, and it is therefore desirable to provide a novel and improved key input device with a backlight which can be constructed with the less number of parts or components.

According to an embodiment of the present disclosure, there is provided a key input device including: plural keycaps used to manipulate key switches, respectively; a backlight radiating a light from a back to the keycap; and a board on which a signal line pattern forming a contact point adapted to be opened or closed in accordance with an up-and-down motion of corresponding one of the plural keycaps, and an electric power line pattern through which an electric power is supplied to the backlight are printed.

According to the construction described above, the signal line pattern for generation of an input signal corresponding to the key depressed, and the electric power line pattern for supply of the electric power to the light source for radiating a light to the keycap are printed on the same board. For this reason, the number of parts or components is further reduced in this case than in the case where the parts or components printed of the electric power line pattern are different from the parts Or components printed of the signal line pattern. For this reason, it is possible to realize the reduction of the assembly man-hours and the material cost.

As set forth hereinabove, according to the present disclosure, the key input device with a backlight can be constructed with the less number of parts or components.

### BRIEF DESCRIPTION OF THE DRAWINGS

FIG. 1 is an exterior appearance view of an information processor including an input device as a key input device according to an embodiment of the present disclosure;

FIG. 2 is a block diagram showing a hardware configuration of the information processor including the input device according to the embodiment of the present disclosure;

FIG. 3 is a schematic view of the input device portion, in the information processor, according to the embodiment of the present disclosure;

FIG. 4 is an exploded perspective view showing a key switch construction of the input device according to the embodiment of the present disclosure;

FIG. 5 is an explanatory view showing an outline of a matrix structure of signal lines for generation of an input signal of the input device according to the embodiment of the present disclosure;

FIG. 6 is an explanatory view showing a wiring pattern of the signal lines and electric power lines on a board of the input device according to the embodiment of the present disclosure;

FIG. 7 is a cross sectional view showing a cross-sectional structure of the input device according to the embodiment of the present disclosure;

FIG. 8 is an explanatory view explaining welding of a mechanical portion of the key switch construction of the input device according to the embodiment of the present disclosure; and

FIG. 9 is an exploded perspective view showing an example of a key switch construction of an existing input device.

### DETAILED DESCRIPTION OF THE PREFERRED EMBODIMENT

A preferred embodiment of the present disclosure will be described in detail hereinafter with reference to the accompanying drawings. It is noted that in this specification and the drawings, constituent elements which have substantially the same functional constructions are designated by the same reference numerals or symbols, respectively, and a repeated description thereof is omitted for the sake of simplicity.

It is noted that the description will be given below in accordance with the following order:

1. Outline;

2. Hardware Configuration; and

3. Key Switch Construction
3-1. Existing Key Switch Construction
3-2. Key Switch Construction in Embodiment
3-3. Board Construction
3-4. Assembly Example

### 1. Outline

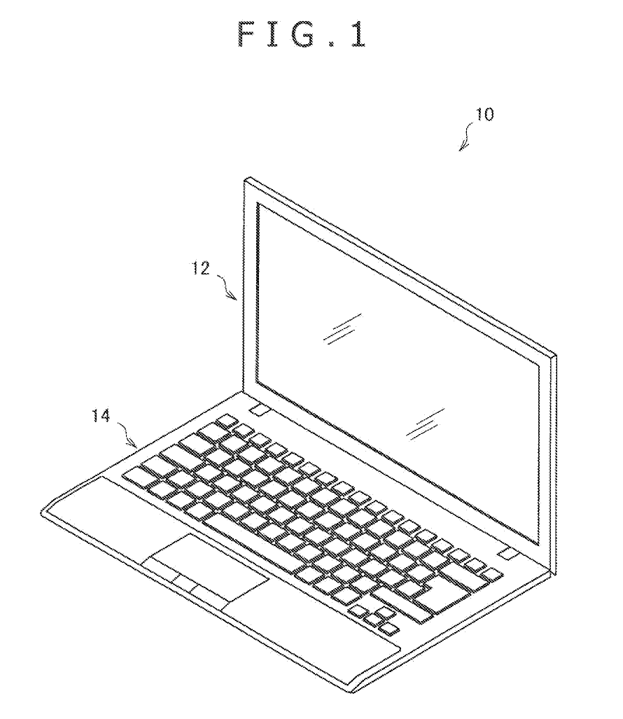

Firstly, an outline of an information processor including an input device as a key input device according to an embodiment of the present disclosure will be described with reference to FIG. 1. FIG. 1 is an exterior appearance view of the information processor including the input device according to the embodiment of the present disclosure.

A notebook-size Personal Computer (PC) 10 is an example of the information processor including the input device. The notebook-size PC 10 includes a chassis 12 on a display device side, and a chassis 14 on the input device side. Note that, in the embodiment which will be descried below, for the purpose of describing the input device as the key input device according to the embodiment of the present disclosure, the notebook-size PC 10 is used. However, the present disclosure is not limited to such an example. The input device according to the embodiment of the present disclosure may be installed in all of other information processors. Or, the input device may be provided separately from the information processor, and thus may transmit an input signal to the information processor through a cable, a communication path or the like.

As described above, for the purpose of realizing lighted (translucent) keycaps, the input device according to the embodiment of the present disclosure includes a backlight. The number of constituent parts or components is larger in the input device including the backlight than in the input device including no backlight. For example, there is known a keyboard in which a light source installed in a part of a light guide plate radiates a light to plural keycaps through the light guide plate. This input device includes the light guide plate as a plate-like member in addition to the construction of the input device not having the backlight. For this reason, the number of constituent parts or components is large, and thus the assembly man-hours are large. In addition, in this input device, a light radiated from one light source is used for illumination for many keycap. For this reason, a photoconduction efficiency is poor, and thus a large electric power is required for obtaining a sufficient luminance.

For this reason, in the embodiment, a description will be given below with respect to the key input device with a backlight which is constructed with a less number of parts or components. The key input device with a backlight is constructed with a less number of parts or components, which results in that the assembly man-hours are reduced. A construction of such an input device will be described below.

### 2. Hardware Configuration

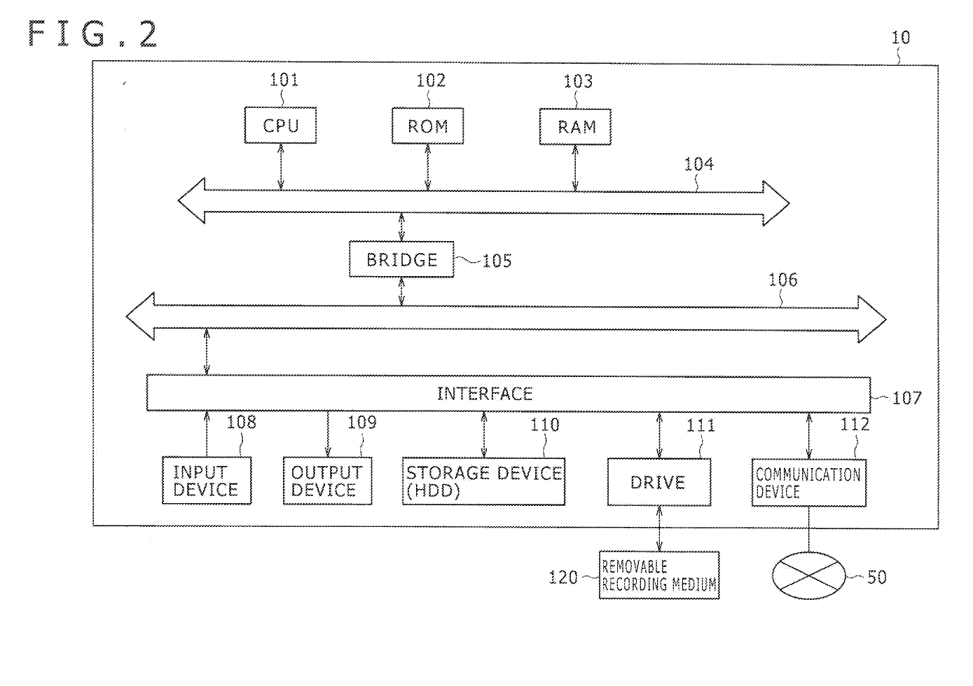

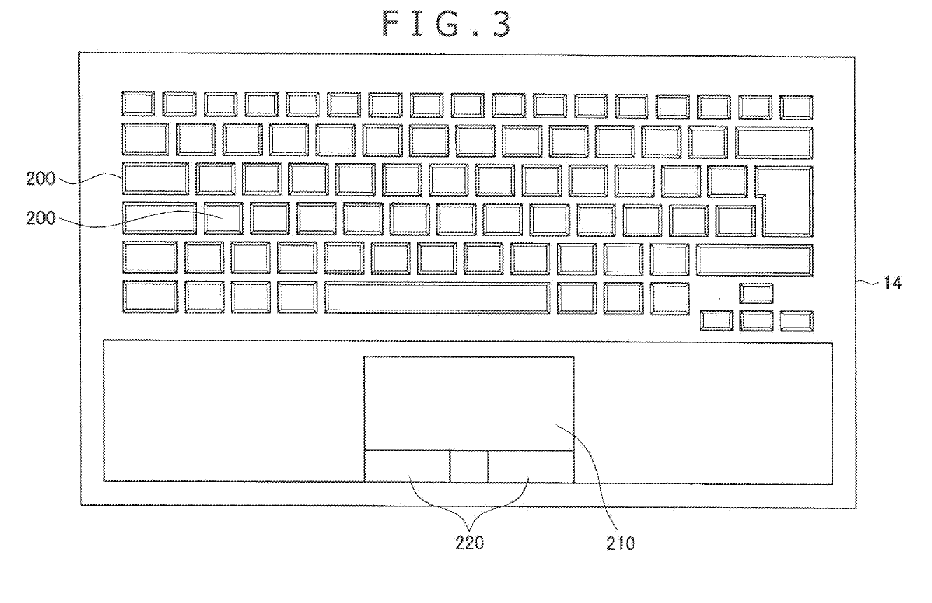

Next, a description will be given below with respect to a hardware configuration of the notebook-size PC 10 as the example of the information processor including the input device according to the embodiment of the present disclosure with reference to FIGS. 2 and 3. FIG. 2 is a block diagram showing a hardware configuration of the information processor including the input device, according to the embodiment of the present disclosure. FIG. 3 is a schematic view of the input device portion, in the information processor, according to the embodiment of the present disclosure.

The notebook-size PC 10 includes a Central Processing Unit (CPU) 101, a Read Only Memory (ROM) 102, a Random Access Memory (RAM) 103, a host bus 104, a bridge 105, and an external bus 106. Also, the notebook-size PC 10 includes an interface 107, an input device 108, an output device 109, a storage device (HDD) 110, a drive 111, and a communication device 112.

The CPU 101 functions as an arithmetic operation processing unit, and a control unit, and controls the entire operation in the notebook-size PC 10 in accordance with various kinds of programs. In addition, the CPU 101 may be composed of a microprocessor. The ROM 102 stores therein programs, arithmetic operation parameters, and the like which the CPU 101 uses. The RAM 103 temporarily stores therein programs used in execution by the CPU 101, parameters which suitably change in the execution of the programs, and the like. The CPU 101, the ROM 102, and the RAM 103 are connected to one another through the host bus 104 composed of a CPU bus or the like.

The host bus 104 is connected to the external bus 106 such as a Peripheral Component Interconnect/Interface (PCI) through the bridge 105. It is noted that the host bus 104, the bridge 105, and the external bus 106 are not necessarily provided separately from one another, and thus the functions of the host bus 104, the bridge 105, and the external bus 106 may also be integrally mounted to one bus.

The input device 108, for example, is composed of an input section, an input control circuit, and the like. In this case, the input section, for example, is composed of a mouse, a keyboard, a touch panel, buttons, a microphone, a switch, a lever, and the like which are used to input information by a user. Also, the input control circuit generates an input signal in accordance with an input manipulation made by the user, and outputs the input signal to the CPU 101. The user of the notebook-size PC 10 can input various kinds of data to the notebook-size PC 10, and instructs the notebook-size PC 10 to carry out a processing operation by manipulating the input device 108.

It is noted that in the embodiment, a keyboard portion of the input device 108 is mainly described. As shown in FIG. 3, the notebook-size PC 10 includes key switches, a touch pad 210, and buttons 220 in the chassis 14 on the input device side, which are operated by manipulating plural keycaps 200. The key switches, the touch pad 210, and the buttons 220 are an example of the input device 108.

The output device 109, for example, is composed of a display device composed of a Cathode Ray Tube (CRT) display device, a Liquid Crystal Display (LCD) device or an Organic Light Emitting Diode (OLED) device, and a lamp, and a sound outputting device composed of a speaker and a headphone. The output device 109, for example, outputs content reproduced. Specifically, the display device displays thereon various kinds of information such as Video data reproduced in the form of a text or an image. On the other hand, the sound outputting device converts the sound data or the like reproduced into a sound and outputs the resulting sound.

The storage device 110 is a data storing device configured as an example of a storage portion of the notebook-size PC 10 including the input device 108 of the embodiment. In this case, the storage device 110 can include a storage medium, a recording device for recording data in the recording medium, a reading device for reading out the data from the storage medium, a deleting device for deleting the data recorded in the storage medium, and the like. The storage device 110 drives a hard disc, thereby storing therein programs which the CPU 101 executes, and various kinds of data.

Here, a non-volatile memory such as a magnetic recording medium such as a Hard Disc Drive (HDD), an Electronically Erasable and Programmable Read Only Memory (EEPROM), a flash memory, a Magnetoresistive Random Access Memory (MRAM), a Ferroelectric Random Access Memory (FeRAM), or a Phase Change Random Access Memory (PRAM) is used as the storage medium of the storage device 110.

The drive 111 is a reader/writer for the storage medium, and is either built in the notebook-size PC 10 or externally mounted to the notebook-size PC 10. The drive 111 reads out the information recorded in a removable storage medium 120 such as a magnetic disc, an optical disc, a magneto optical disc or a semiconductor memory which is installed in the notebook-size PC 10, and outputs the information thus read out to the RAM 103.

The communication device 112, for example, is a communication interface composed of a communication device or the like through which the notebook-size PC 10 is connected to a communication network 50. In addition, the communication device 112 may be a communication device for a wireless Local Area Network (LAN), a communication device for a wireless USB, or a wired communication device for making a communication in a wired manner.

### 3. Key Switch Construction

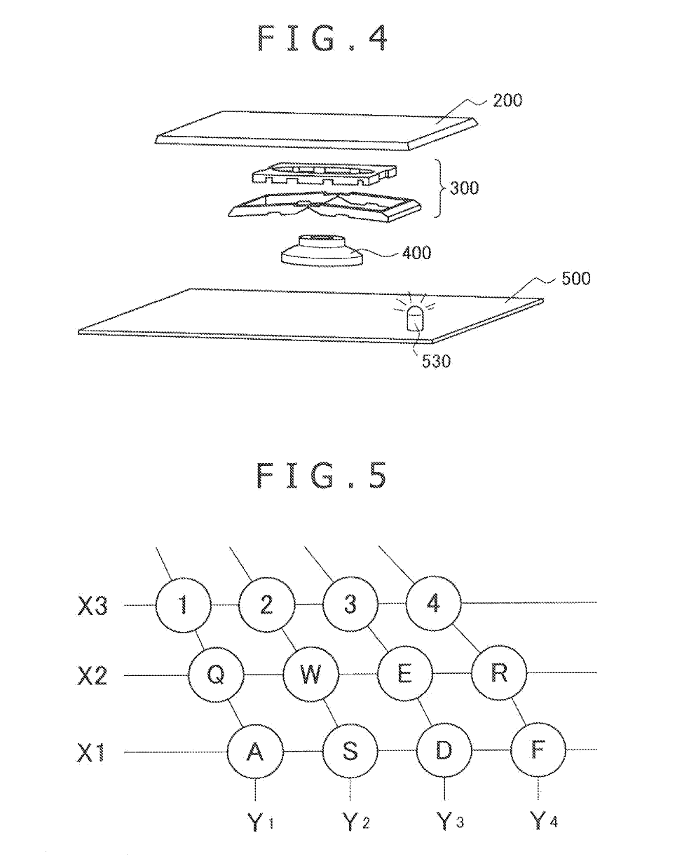

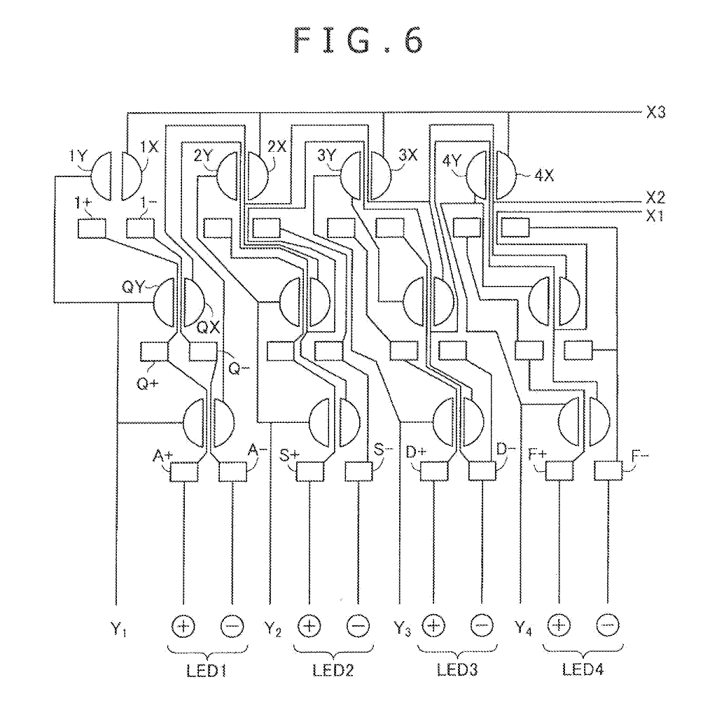

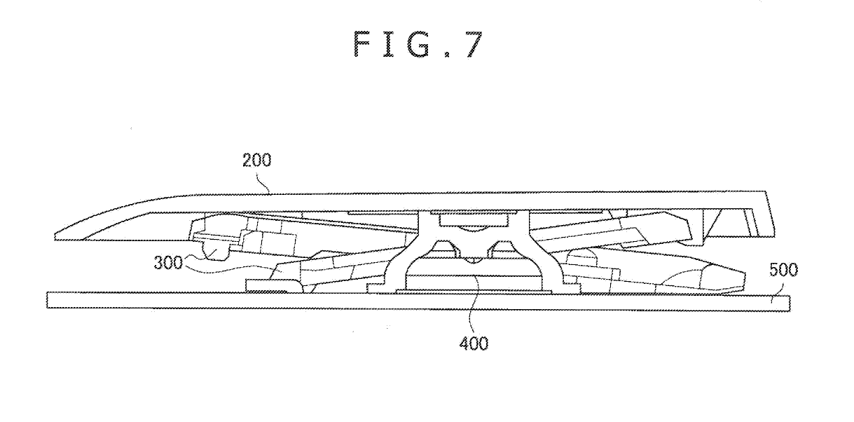

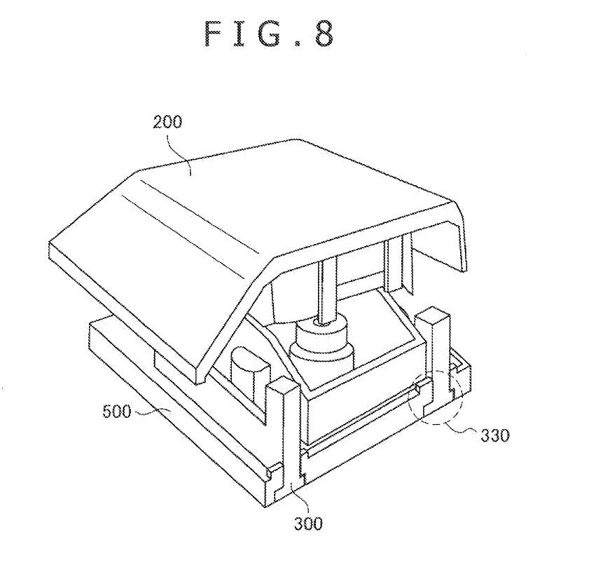

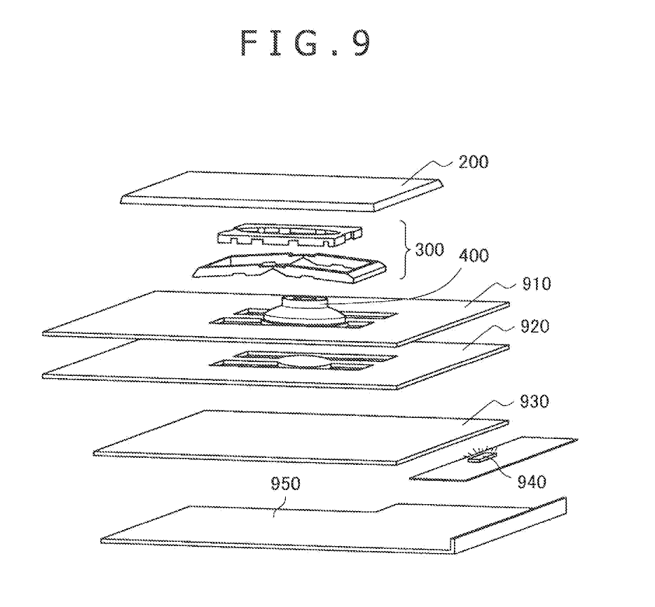

Next, an example of a key switch construction in the embodiment will be described with reference to FIGS. 4 to 9 while it is compared with an example of an existing key switch construction. FIG. 4 is an exploded perspective view showing a key switch construction of the input device according to the embodiment of the present disclosure. FIG. 5 is an explanatory view showing an outline of a matrix structure of signal lines for generation of an input signal of the input device according to the embodiment of the present disclosure. FIG. 6 is an explanatory view showing a wiring pattern of the signal lines and electric power lines on the board of the input device according to the embodiment of the present disclosure. FIG. 7 is a cross sectional view showing a cross-sectional structure of the input device according to the embodiment of the present disclosure. FIG. 8 is an explanatory view explaining welding of a mechanical portion of the key switch construction of the input device according to the embodiment of the present disclosure. Also, FIG. 9 is an exploded perspective view showing an example of a key switch construction of an existing input device.

The key input device typically realized as the keyboard inputs input signals allocated to the respective key switches in the order of typing. Each of the key switches is a switch for passing/cutting off a signal. Thus, each of the key switches is held in an OFF state in a normal state, and is held in an ON state in state in which it is depressed. In order to realize this function, each of the key switches mainly includes a manipulation portion, an actuator, and a switch portion. In this case, the manipulation portion is used to manipulate corresponding one of the key switches. The actuator produces a feel in the process of causing the corresponding one of the keycaps to make an up-and-down motion, and depressing corresponding one of the keycaps, a so-called type touch. Also, the switch portion generates an input signal corresponding to the up-and-down motion of the corresponding one of the keycaps. In addition, in order to realize the lighted (i.e., translucent) keycaps, the key input device includes a light source portion in addition to the manipulation portion, the actuator, and the switch portion as described above.

### 3-1. Existing Key Switch Construction

Here, firstly, a key switch construction of an existing input device will be described with reference to FIG. 9. According to the exiting input device shown in FIG. 9, a key switch mainly includes a keycap 200, a mechanical portion 300, a rubber dome 400, a mechanical mounting plate 910, a membrane sheet 920, a light guide plate 930, a light source 940, and a supporting plate 950.

The keycap 200 is an example of a manipulation portion used to manipulate corresponding one of the keys. A part of the keycap 200 includes a transmission portion for transmitting a light radiated from a lower portion. A character, a symbol or the like data on which can be inputted by manipulating the keycap 200 is generally described on a front surface of the keycap 200. Or, characters representing manipulation contents data on which can be inputted by manipulating the keycap 200 are described on the front surface of the keycap 200.

The mechanical portion 300 and the rubber dome 400 are an example of the actuator for, when the keycap 200 is depressed, producing a feel in the process of causing the key to make the up-and-down motion, and depressing the key, a so-called type touch. The mechanical portion 300 is fixed to the mechanical mounting plate 910, thereby holding the keycap 200. The mechanical portion 300 plays a part for holding the keycap 200 in a normal position, and assisting the up-and-down motion until the state is returned from the depressed state back to the normal position again when the keycap 200 is depressed by the user.

The rubber dome 400 is a dome-like spring. In addition, in the embodiment, the rubber dome 400 is deformed with the depression of the keycap 200 to connect contact points, of a signal pattern, which are formed in the membrane sheet 920.

The mechanical mounting plate 910 is a plate-like member for mounting thereto the mechanical portion 300. The mechanical mounting plate 910 preferably has a transmission property in order to transmit the light radiated through the light guide plate 930.

The membrane sheet 920 is constructed in such a way that an insulating sheet having a hole formed therein is sandwiched between two sheets of thin films. When the keycap 200 is depressed, the two sheets of thin films contact each other through a portion of the insulating sheet having the hole formed therein. The contact points are provided in the portions, respectively, at which the two sheets of thin films contact each other. When the contact points contact each other, the membrane sheet 920 generates the input signal.

The light guide plate 930 is a plate-like member which transmits the light radiated from the light source 940. It is noted that although not illustrated, the light guide plate 930 is provided over a lower portion area of plural keycaps 200, and has a function of illuminating the plural keycaps 200.

The light source 940, for example, is composed of a light emitting element such as a Light Emitting Diode (LED). The light source 940 illuminates the keycap 200 through the light guide plate 930 with the light radiated therefrom.

The supporting plate 950 supports the keycap 200, the mechanical portion 300, the rubber dome 400, the mechanical mounting plate 910, the membrane sheet 920, the light guide plate 930, and the light source 940. Preferably, the supporting plate 950 has a certain level of strength so as to withstand a pressure in a phase of typing.

As has been described so far, since the existing key switch construction includes plural plate-like members and has a large number of constituent parts or components, the assembly man-hours are large. On the other hand, in the key switch construction according to the embodiment which will be described below, a signal line pattern for generation of an input signal, and an electric power supply pattern for supply of an electric power to an LED 530 as a light source are printed on a board 500. In addition, the mechanical portion 300, the rubber dome 400, and the LED 53.0 are directly bonded to the board 500. As a result, the construction is simplified.

### 3-2. Key Switch Construction in Embodiment

Next, the key switch construction of the input device according to the embodiment of the present disclosure will be described with reference to FIG. 4. According to the key switch construction in the embodiment, the key switch mainly includes the keycap 200, the mechanical portion 300, the rubber dome 400, the board 500, and the LED 530.

The keycap 200 is an example of a manipulation portion for manipulating the key switch. The keycap 200 is held by the mechanical portion 300. A part of the keycap 200 includes a transmission portion for transmitting a light radiated from a lower portion. A character, a symbol or the like data on which can be inputted by manipulating the keycap 200 is generally described on a front surface of the keycap 200. Or, characters representing manipulation contents data on which can be inputted by manipulating the keycap 200 are described on the front surface of the keycap 200.

The mechanical portion 300 and the rubber dome 400 are an example of the actuator for, when the keycap 200 is depressed, producing a feel in the process of causing the key to make the up-and-down motion, and depressing the key, a so-called type touch. The mechanical portion 300, for example, is fixed to the board 500, thereby holding the keycap 200. The mechanical portion 300 plays a part for holding the keycap 200 in a normal position, and assisting the up-and-down motion until the state is returned from the depressed state back to the normal position again when the keycap 200 is depressed by the user. The rubber dome 400 is a dome-like spring. In addition, in the embodiment, the rubber dome 400 is deformed with the depression of the keycap 200 to contact a contact point of the signal pattern formed on the board 500. As a result, the rubber dome 400 opens or closes the contact in accordance with the up-and-down motion by the keycap 200. For this reason, at least a portion of the rubber dome 400 contacting the contact point has a conductive property.

The board 500 has a function of a switch portion for generating the input signal corresponding to the up-and-down motion of the keycap 200. The board 500, for example, is composed of a glass epoxy printed wiring board. The signal circuit pattern in which the contact point for generation of the input signal is provided is formed on the board 500. In the signal circuit pattern, the contact point is provided in a position corresponding to the key position. In addition, the electric power supply pattern for supply of the electric power to the LED 530 is formed on the board 500. In the electric power supply pattern, a plus contact point and a minus contact point for supply of the electric power to the LED 53Q are each provided in the position corresponding to the key position. The LED 530 has a plus terminal and a minus terminal which are mounted to the plus contact point and the minus contact point of the electric power supply pattern by the soldering, respectively. It is noted that details of the board 500 will be described later.

The LED 530 is an example of the light source for radiating a light from the lower side to the keycap 200 an the board 500. At this time, preferably, the LED 530 is disposed in a position where the light can be radiated to the entire surface of the keycap 200. In addition, the LED 530 may be composed of a near-ultraviolet LED for radiating a near ultraviolet. For example, when a luminous material is contained in the keycap 200, there is obtained an effect that the near-ultraviolet LED is used, thereby enhancing the luminous efficiency of the luminous material used in the keycap 200.

### 3-3. Board Construction

Next, a detailed construction of the board 500 in the embodiment will be described with reference to FIGS. 5 and 6. FIG. 5 is an explanatory view showing an outline of a matrix structure of signal lines for generation of an input signal of the input device according to the embodiment of the present disclosure. FIG. 6 is an explanatory view showing a wiring pattern of the signal lines and electric power lines on a board of the input device according to the embodiment of the present disclosure.

In the signal line pattern formed on the board 500, as shown in FIG. 5, an X line in a transverse direction, and a Y line in a longitudinal direction intersect with each other in a position corresponding to the disposition of the keycap 200 to form a contact point. The contact point is opened or closed in accordance with the up-and-down motion of the keycap 200. That is to say, the contact point is composed of an X contact point connected to the X line, and a Y contact point connected to the Y line. Also, the X contact point and the Y contact point are held in an “open” state (that is, in a state in which the X contact point And the Y contact point are not connected to each other) when the keycap 200 is held in a normal position. On the other hand, the X contact point and the Y contact point are held in an “close” state (that is, in a state in which the X contact point and the Y contact point are connected to each other) when the keycap 200 is depressed to depress the rubber dome 400, so that the portion of the rubber dome 400 having the conductive property contacts both of the X contact point and the Y contact point.

The signal line pattern and the electric power line pattern are both formed on the board 500. Each of the signal line pattern and the electric power line pattern, for example, is composed of a printed wiring. FIG. 6 shows an example of wirings of the signal line pattern and the electric power line pattern.

For example, in FIG. 5, a contact point 1 at which a signal line X3 and a signal line Y1 intersect with each other is composed of a Y contact point 1Y and an X contact point 1X in FIG. 6. In addition, a terminal which is connected to the electric power line for supply of the electric power to the LED 530 is provided in the vicinity of the contact point 1. That is to say, a contact point 1 plus and a contact point 1 minus of FIG. 6 are mounted to the plus terminal and the minus terminal of the LED 530, respectively, by the soldering. That is to say, the Y contact point 1Y, the X contact 1X, the contact point 1 plus, and the contact point 1 minus are all provided on a back of the keycap 200 made to correspond to the contact point 1. That is to say, the LEDs 530 are provided so as to correspond to the keycaps 200, respectively.

It is noted that in the board 500, a shock is given to the contact point whenever the keycap 200 is depressed. For this reason, a material having a durability is preferably used in the board 500. The board 500 may be composed of a rigid board. More specifically, the board 500 may also be composed of a glass epoxy board.

### 3-4. Assembly Example

The main constituent elements composing the key switch of the input device according to the embodiment have been described so far. These constituent elements, for example, are assembled as shown in FIG. 7. As a result, when the keycap 200 is depressed by the user, both of the mechanical portion 300 and the rubber dome 400 are pushed downward. At this time, the rubber dome 400 is deformed to connect the contact points on the board 500 to each other. When the contact points are connected to each other in such a way, the input signal corresponding to the contact points thus connected is generated. It is noted that the actuator including both of the mechanical portion 300 and the rubber dome 400 may be directly bonded to the board 500.

It should be noted that the physical construction shown here is merely an example, and thus the present disclosure is hot limited to such an example. For example, in the key switch construction shown in FIG. 7, unlike the example shown in FIG. 4, a pantograph type actuator is used as the mechanical portion 300. In addition, a construction may also be adopted such that the mechanical portion 300 is omitted.

It is noted that in the key switch of the input device according to the embodiment, the mechanical portion 300 is directly welded to the board 500. An example of a situation of the welding is shown in FIG. 8. The mechanical portion 300 is welded to the board 500 by utilizing welding holes provided in the board 500. A portion 330 shows the situation in which the mechanical portion 300 is welded to the board 500 after portions of the mechanical portion 300 are inserted into the welding holes, respectively.

Although the preferred embodiment of the present disclosure has been described so far with reference to the accompanying drawings, the present disclosure is not limited thereto. It is obvious that a person who has a normal knowledge in the technical field to which the present disclosure belongs hits upon various kinds of changes or modifications within the category of the technical idea disclosed in the appended claims. Also, it is understood that the various kinds of changes or modifications naturally belongs to the technical scope of the present disclosure.

The present disclosure contains subject matter related to that disclosed in Japanese Priority Patent Application JP 2010-282893 filed in the Japan Patent Office on Dec. 20, 2010, the entire content of which is hereby incorporated by reference.

What is claimed is:

1. A key input device comprising:
plural keycaps used to manipulate key switches, respectively;
a backlight radiating a light from a back to the keycap; and
a board on which a signal line pattern forming a contact point adapted to be opened or closed in accordance with an up-and-down motion of corresponding one of said plural keycaps, and an electric power line pattern through which an electric power is supplied to said backlight are printed.

2. The key input device according to claim 1, wherein said board is a rigid board.

3. The key input device according to claim 1, wherein the backlights are provided in backs of said plural keycaps, respectively.

4. The key input device according to claim 1,
wherein said key switch has an actuator for causing the keycap to make an up-and-down motion on the back of the keycap, and
said actuator is welded to said board.

5. The key input device according to claim 2, wherein said board is a glass epoxy board.

6. The key input device according to claim 4, wherein at least a part of said actuator has a conductive property, and when the keycap is depressed, said contact point and said at least a part of said actuator having the conductive property contact each other, thereby generating an input signal.
